(19) United States
(12) Patent Application Publication
(10) Pub. No.: US 2009/0005025 A1
(43) Pub. Date: Jan. 1, 2009

(54) METHOD OF MAKING A USER INTERFACE APPLICATION COMPRISING A TEMPORARY INVERSION SEQUENCE

(75) Inventors: Olivier IRAC, St Leu la Foret (FR); Cedric Pulrulczyk, Acquigny (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 12/147,780

(22) Filed: Jun. 27, 2008

(30) Foreign Application Priority Data
Jun. 29, 2007 (FR) 0756154

(51) Int. Cl. H04M 3/00

(52) U.S. Cl. 455/418

(57) ABSTRACT

Method of executing an interactive user interface application between a terminal client (2) installed at a user and a resource centre server (1) within a network, characterised in that to perform an interaction, it comprises a temporary inversion sequence comprising steps to:
the client (2) sends a message (20) to initialise a temporary inversion sequence to the server (1), and
the client (2) starts a client alternative module,
the server (1) receives said initialisation message (20), and
the server (1) starts a server alternative module controlling execution of the user interface sequence,
the server (1) sends a termination message (24) to the client (2) to terminate the temporary inversion sequence when the interaction is terminated.

This invention relates to a method of making an interactive user interface application comprising a temporary inversion sequence.

In the field of communication networks comprising at least one resource centre server and a plurality of terminal clients each installed at a user, said user uses his terminal to request services from said server. Initial telephony applications are now more diversified and offer an increasing variety of services such as fax, email, internet browsing, remote broadcasting of radio programs, and television or video programs. Such offers present new challenges, in that the structure and nature of parameters to be exchanged between the user and the server may be very varied, in that they concern a wide variety of aspects such as transmission of programs on line, choice of a radio channel or television channel, exchanges necessary to set up content transmission, or aspects related to invoicing of services. Some of these aspects are also changing very quickly to monitor fast changes in offers or commercial practice.

An interactive user interface application should be set up in order to make all preparatory exchanges before the server can supply a service to the user of a terminal. In the case of a network, such an application is distributed between the terminal client and the resource centre server. Interactive exchanges between the user through his terminal and the server, provide a means of agreeing on the exact content of the service that the server will then offer to the user, through user choices. According to a typical scenario, the client terminal will display pages to the user displaying the possibilities of the services offered by the server. The user selects one of the choices offered to him and firstly makes choices and secondly allows the application to continue. Depending on the user's choices, the user interface application firstly defines the expected service and secondly, if applicable, displays appropriate new pages to the user so that he can interactively specify other parameters necessary for the service.

Therefore, such an interactive user interface application comprises a “server” part or module running on the resource server and a “client” part or module running on the terminal client. These two parts dialogue together through the network and together form the interactive user interface application.

At the moment, the client module is responsible for the dialogue and manages the interface logic. Thus, the client part contains interface definition elements. Interactive pages are predefined within the client module and the client module displays said pages on the terminal for the attention of the user. These pages comprise placeholders for variable fields. These variable fields contain only modifiable elements not predefined within the client. They are defined from data provided by a server module. In this way, only one value can be modified.

Thus for example, a menu offering the user two subscription options, namely 1 month for 18 [symbol] or 6 months for 90 [symbol] , would contain four variable fields, namely 1 m, 18 [symbol] , 6 m, 90 [symbol] , the values of which can be modified by changing these values within the server module. However, a third option cannot be added without modifying the client module.

Current practice is justified and has the advantage that it leaves the client module to be responsible for the dialogue and can give good response times due to good use of the local processing power at the client. These response times are guaranteed, because they are not governed by uncontrollable problems that might arise in a network transmission.

However, this practice also has the major disadvantage that it limits the user interface application to be changed. Modifying the dialogue structure requires a modification to the client module. Such a modification is very difficult in practice because clients are inherently numerous and are distributed among a multitude of users. It would be easier to limit modifications at the server, due to its central nature.

This invention overcomes these various disadvantages by offering an interactive user interface application, in which the responsibility for the dialogue may be inverted. According to one nominal mode, the user interface application makes the client responsible for the dialogue. Nevertheless, it is possible to make a temporary inversion sequence during which the server is made responsible for the dialogue. Thus for some interactions, the client can temporarily transfer responsibility for the dialogue to the server. The server returns said responsibility to the client at the end of the interaction.

The purpose of the invention is a method of executing an interactive user interface application distributed between a terminal client installed at a user and a resource centre server within a network, characterised in that to perform an interaction, it comprises a temporary inversion sequence comprising steps to:

the client sends a message to initialise a temporary inversion sequence to the server, and

the client starts a client alternative module
displaying interactive pages on the terminal for the attention of the user,
reading user choices in return, to transmit them to a server alternative module,

the server receives said initialisation message, and

the server starts said server alternative module:
producing interactive pages that can be displayed by said client alternative module,
transmitting said interactive pages to the client alternative module,
receiving user choices in return from the client alternative module, so as to control execution of the user interface sequence,

the server sends a termination message to the client to terminate the temporary inversion sequence when the interaction is terminated.

According to another characteristic of the invention, the method also includes the following steps prior to the inversion sequence:
the client executes a client nominal module:
displaying interactive pages on the terminal for the attention of the user predefined within the client nominal module, containing variable fields, values of said variable fields being defined from data supplied by a server nominal module,
reading the user's interactive choices in return, and
processing said interactive choices so as to control execution of the user interface sequence,
the server executes a server nominal module capable of satisfying data request output from the client nominal module.

According to another characteristic of the invention,
the temporary inversion sequence initialisation message sent by the terminal is accompanied by an end of execution report for the client nominal module,
the temporary inversion sequence initialisation message received by the resource centre is accompanied by an end of execution report for the server nominal module.

According to another characteristic of the invention, the method also includes the following steps:
the terminal receives the temporary inversion sequence termination message
the client starts a client nominal module:
interactive pages predefined within the client nominal module are displayed on the terminal for the attention of the user, comprising variable fields, the values of said variable field being defined from data supplied by a server nominal module,
in return, reading the user's interactive choices, and
processing them so as to check execution of the sequence of the user interface,
the server starts a server nominal module capable of satisfying data request output from the client nominal module.

One advantage of the method according to the invention is that two modes (nominal and alternative) are set up, each with their corresponding advantages, and these modes can be inverted so as to benefit from whichever advantages are most suitable for the interaction, depending on the interaction type.

Other characteristics, details and advantages of the invention will become clearer after reading the detailed description given below for information in relation with the drawings on which:

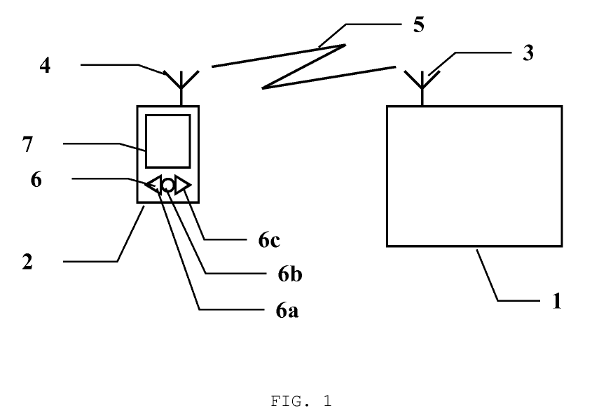

FIG. 1 shows a network containing a server and a client,

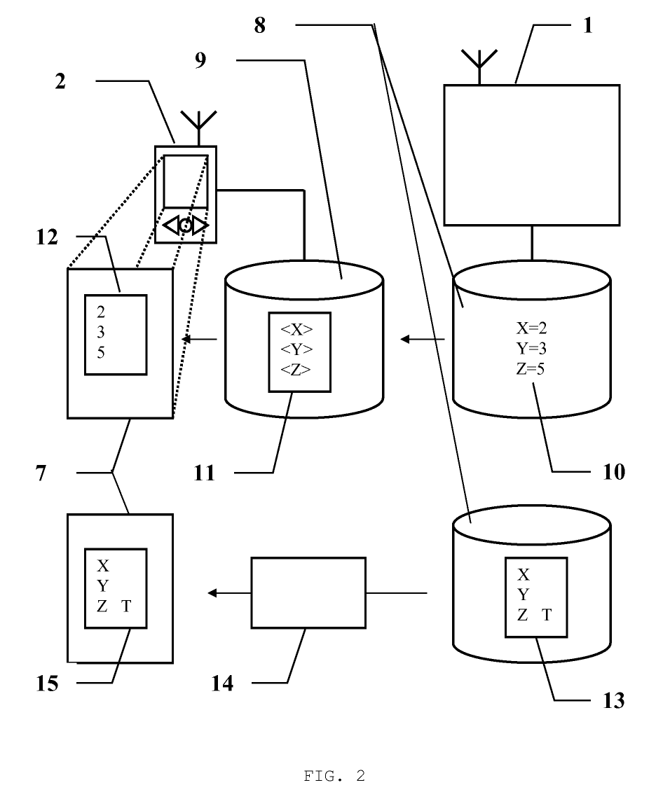

FIG. 2 shows the construction of an interactive page according to the nominal mode and according to alternative mode,

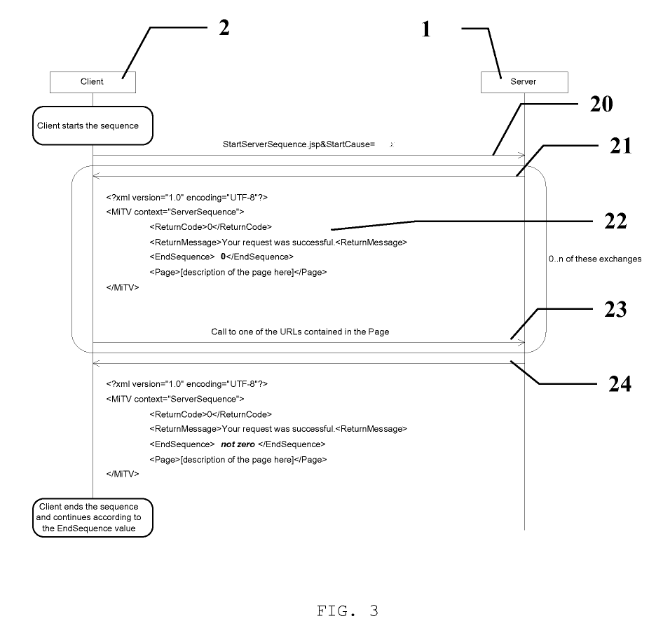

FIG. 3 is a chronological principle diagram of a temporary inversion sequence,

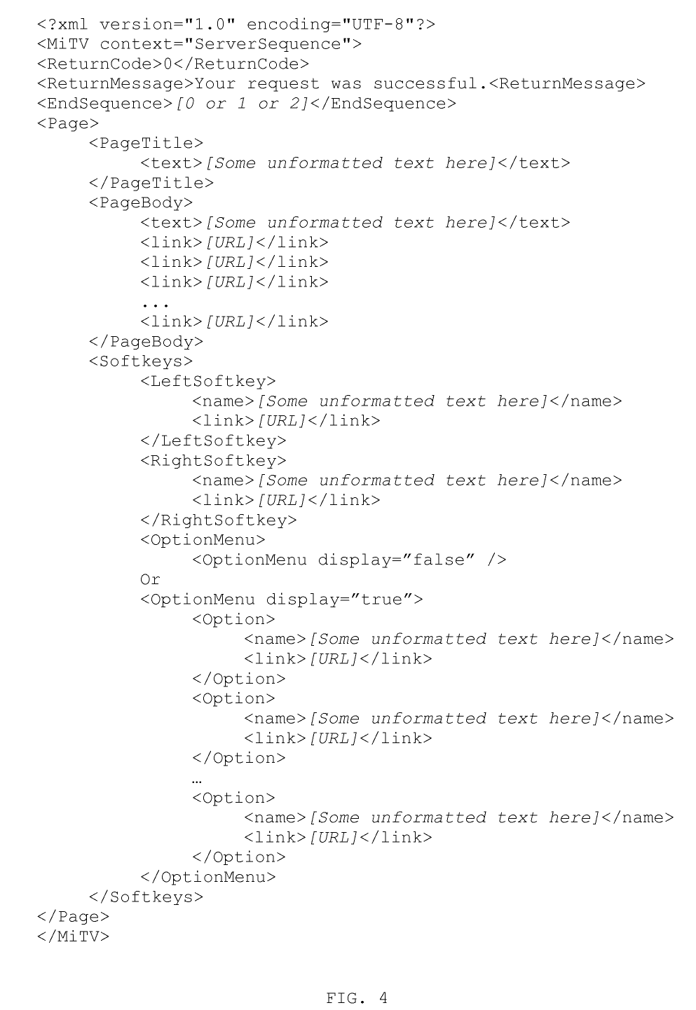

FIG. 4 is an example of the syntax of an XML page in alternative mode.

According to FIG. 1, a network resource centre server 1 and a terminal client 2 jointly execute an interactive user interface application. To achieve this, said application is distributed between a server module executed by the server 1 and a client module executed by the client 2. For the needs of the application, these two server and client modules exchange data between themselves through the network infrastructure. For illustration purposes, the network is a wireless radio network in this case represented by a server antenna 3, a client antenna 4 and radio radiation 5. However, the invention is applicable to any wired or wireless network. Choices made by the user of the terminal client 1 are all made at the terminal client 1. To do this, the terminal client 1 comprises at least one display screen 7 to present pages to the user, and an input device 6 that the user can use to browse in and between interactive pages and make choices. The input device 6 is shown for example as being a keyboard comprising two browsing arrows 6a, 6c and a select key 6b.

FIG. 2 shows two operating modes (nominal and alternative) according to the invention.

According to the nominal mode, which is the only mode existing in the state of the art, the user interface application is distributed in two modules that dialogue with each other through the network. A first client nominal module is executed by the client 2, while a second server nominal module is executed by the server 1.

The essential difference between these two modes is the way in which an interactive page is created, so that it can be presented to the user. A first “line” in FIG. 2 represents the server 1 and the client 2. There is a second line below illustrating the nominal mode and a third line illustrating the alternative mode.

In nominal mode, a page 12 presented to the user on the screen 7 of the client terminal 2 is built by the client 2 within the client nominal module. To do this, the memory 9 of the client 2 contains the complete structure of the page 11. Similarly, actions to be carried out as a function of choices made by the user that control the logic of the dialogue and particularly the chaining of pages and/or actions to be triggered, are predetermined and are contained in the memory 9 of the client 2. The only possible configuration is obtained through the placeholders represented by the < > symbols surrounding a parameter name. Thus, the model page 11 shown in FIG. 2 comprises three variable fields <X>, <Y> and <Z>. When the application has to display a final page 12, a model page 11 is extracted from the memory 9 of the client 2. The variable fields <X>, <Y> and <Z> are instantiated with values X, Y, Z. To achieve this, the client nominal module makes an exchange with the server nominal module. The server nominal module consults the memory 8 of the server 1 and extracts values 10 from it. In the example, X is equal to 2, Y is equal to 3 and Z is equal to 5. The client nominal module replaces the parameters by said values at the determined placeholders <X>, <Y> and <Z> in the model page 11, so as to produce the final page 12.

In this nominal mode, the result of the operating method is that only the values 10 are known and can be modified by the server 1. The entire logic of the user dialogue of the application and the structure of pages are defined in the client 2 and its memory 9, a modification of the dialogue logic or the structure of a page requires a modification of the client 2. This is the type of solution currently used for most applications on the market due to its good performances in terms of response time. Since the elements are available locally, the client nominal module can access them quickly, even if the network is disturbed or missing. The client 2 is responsible for and controls the user dialogue logic. This is suitable for applications managing typical interactions that change only little.

In order to be able to offer greater changeability of the dialogue and therefore of the application as a whole, the invention offers a second mode or alternative mode in which the structure of pages and the dialogue logic are stored on the server 1. This makes this information easier to modify, central and therefore unique. This alternative mode is also called the “browser” mode because it is similar to exchange mode between a client of a web “browser” and its server. To achieve this, all elements controlling the user dialogue are present on the server 1. Thus complete pages, including elements to be displayed and also the user's possible choices in reply, and actions triggered by the application in reply to the different choices, are entirely defined within the pages 13 stored in the memory 8 of the server 1. FIG. 4 shows an example listing of a page in a classical XML data description language. In this alternative mode, the server alternative module transmits a page 13 to the client alternative module. This page 13 may be described in any adapted data description language, for example in XML. If applicable, this page is interpreted by an interpreter 14 so as to translate it into a form that can be understood by the client alternative module, so that it can be displayed on the screen 7 of the client 2 for the attention of the user. A page 13 contains displayable elements and their layout in the page, and also choices offered to the user and actions associated with these choices. The client alternative module simply displays the page and returns actions associated with the choices made by the user using the input device 6, to the server. Thus, the server 1 controls the logic of the user dialogue and is responsible for it. A modification of an application for a given interaction requires only a central modification of the server alternative module and can then be propagated and made accessible to all clients of the network.

Considering these advantages, it can be seen that the alternative mode enables considerable changeability concerning the structure, content and organisation of a user dialogue. However, such a mode makes the client 2 much more dependent on the server 1. A larger volume of data has to be exchanged between the client 2 and the server 1, a complete page 13 being larger than the data 10. Similarly, the client alternative module is a simple display and it cannot execute anything alone if there is a network transmission problem.

According to one characteristic of the invention, it is proposed to make an interactive user interface application distributed between a terminal client 2 and a resource centre server 1 on a network, using the nominal mode as described above by default and using the alternative mode for the needs of some particular applications, for example applications liable to frequent changes.

The transition must be managed when changing from one mode to another. According to one characteristic of the invention, this is achieved by performing a temporary inversion sequence.

In nominal mode in which the application comprises a client nominal module running on the client 2, and a server nominal module running on the server 1 and dialoguing with each other, the interactive user interface application changes to alternative mode based on the following sequence of steps:

the client 2 sends a temporary inversion sequence initialisation message to the server 1, and

starts a client alternative module,

the server 1 receives the initialisation message, and

starts the server alternative module.

the server 1 sends a message to the client 2 to terminate the temporary inversion sequence, when the interaction is terminated.

The functions of the client alternative module are:

display interactive pages on the terminal client 2, for the attention of the user,

in return, read the user's choices and transmit to the server alternative module.

The functions of the server alternative module are:

production, for example by extraction from a memory storage 8, of interactive pages that can be displayed by the client alternative module,

transmission of said interactive pages to the client alternative module,

reception of user choices in return from the client alternative module. Depending on these choices, the server alternative module checks execution of the sequence of the user interface, by selecting the new page to be displayed or the action to be controlled.

During the inversion sequence, when alternative modules are operational, the application is in alternative mode.

Thus, it can be seen that the client 2 uses a temporary inversion sequence initialisation message to initiate the inversion sequence, during which it transmits responsibility for the user dialogue to the server 1. When the sever 1 has terminated the interaction for which it was made responsible, the server 1 terminates the sequence by sending a temporary inversion sequence termination message to the client 2 to inform the client that responsibility for the user dialogue has been returned to it.

This is illustrated again in FIG. 3, that shows the principle of the inversion sequence. FIG. 3 shows the client 2 in the left column, the server 1 in the right column and the different exchanges between them by annotated arrows. The inversion sequence comprises the following steps. The client 2 sends a temporary inversion sequence initialisation message 20 to the server 1. After reception of said initialisation message, the server 1 sends at least one message 21 containing all elements and particularly the definition of a page 22. The client 2 replies with a message 23 containing the user's choices, for example in the form of URLs associated with said page. The previous exchange of messages 21, 23 can occur as many times as necessary to execute an interaction. Finally, when the interaction is terminated, the server 1 sends a temporary inversion sequence termination message 24 to the client 2.

The application operates in nominal mode before or after a temporary inversion sequence. In this nominal mode, the client 2 executes a client nominal module, while the server 1 executes a server nominal module.

The functions of the client nominal module are:

display interactive pages 12 predefined within the client nominal module, for example in a memory 9 of the client 2, on the screen 7 of the client 1. These pages 12 may comprise variable fields, values of said variable fields being defined from data 10 supplied by the server nominal module,

in return, read the user's interactive choices,

processing of said interactive choices, to check execution of the user interface sequencing.

The function of the server nominal module is to reply to data requests 10 output from the client nominal module.

The different modules (both client and server) are entities or parts of the application. They may be routines, tasks or any other equivalent means. These modules are executed as a function of the need, and their execution may be terminated or they may simply be put into a sleep mode when they are not used.

FIG. 4 presents an example of syntax that could be used in alternative mode to define a page 13 transmitted by the server 1 to the client 2. Such a page 13, described herein in the XML language, comprises the following descriptive blocks. Firstly there is a header block, and then the ReturnCode, ReturnMessage and EndSequence blocks that determine the behaviour of the client on reception of the page. The page itself is then defined by a title indicated by the PageTitle block, a body defined by the PageBody block, an action associated with the user pressing a left key 6a defined by a LeftSoftKey block, and an action associated with the user pressing or a right key 6c defined by a RightLeftSoftKey block. These blocks comprise a text displayed on a screen corresponding to the real key 6a, 6c and a URL that is returned to the server 1 when the user selects the associated key. The OptionMenu block defines the presence and content of an optional menu.

1. Method of executing an interactive user interface application distributed between a terminal client (2) installed at a user and a resource centre server (1) within a network, characterised in that to perform an interaction, it comprises a temporary inversion sequence comprising steps to:
the client (2) sends a message (20) to initialise a temporary inversion sequence to the server (1), and
the client (2) starts a client alternative module
displaying interactive pages on the terminal for the attention of the user,
reading user choices in return, to transmit them to a server alternative module,
the server receives said initialisation message (20), and
the server starts said server alternative module:
producing interactive pages that can be displayed by said client alternative module,
transmitting said interactive pages to the client alternative module,
receiving user choices in return from the client alternative module, so as to control execution of the user interface sequence,
the server (1) sends a termination message (24) to the client (2), to terminate the temporary inversion sequence when the interaction is terminated.

2. Method according to claim 1, in which the method also includes the following steps prior to the inversion sequence:
the client (2) executes a client nominal module:
displaying interactive pages on the terminal for the attention of the user predefined within the client nominal module, containing variable fields, values of said variable fields being defined from data (10) supplied by a server nominal module,
reading the user's interactive choices in return, and
processing said interactive choices so as to control execution of the user interface sequence,
the server (1) executes a server nominal module capable of satisfying data request output from the client nominal module.

3. Method according to claim 2, in which:
the temporary inversion sequence initialisation message (20) sent by the terminal is accompanied by an end of execution report for the client nominal module,
the temporary inversion sequence initialisation message (20) received by the resource centre is accompanied by an end of execution report for the server nominal module.

4. Method according to claim 3, in which the method also includes the following steps:
the client (2) receives the temporary inversion sequence termination message (24),
the client (2) starts a client nominal module:
interactive pages predefined within the client nominal module are displayed on the client (2) for the attention of the user, comprising variable fields, the values of said variable field being defined from data (10) supplied by a server nominal module,
in return, reading the user's interactive choices, and
processing them so as to check execution of the sequence of the user interface,
the server (1) starts a server nominal module capable of satisfying data request output from the client nominal module.
